(19) United States
(12) Patent Application Publication
(10) Pub. No.: US 2008/0190282 A1
(43) Pub. Date: Aug. 14, 2008

(54) Lockable Working Cylinder

(75) Inventor: Adolf Tretsch, Stockach (DE)

Correspondence Address: BACHMAN & LAPOINTE, P.C., 900 CHAPEL STREET, SUITE 1201, NEW HAVEN, CT, 06510, US

(73) Assignee: AROS HYDRAULIK GMBH, Memmingen (DE)

(21) Appl. No.: 11/910,275

(22) PCT Filed: Mar. 24, 2006
(86) PCT No.: PCT/EP2006/002737

§ 371 Date: Oct. 1, 2007

(30) Foreign Application Priority Data
Mar. 31, 2005 (DE) 10 2005 015 059.4

(51) Int. Cl. F15B 15/26

(52) U.S. Cl. 92/17

(57) ABSTRACT

A lockable working cylinder comprising a housing and a piston that can be displaced in a primary pressure chamber of the housing. A piston rod tube leads from the piston out of the pressure chamber and a spindle rotates in the piston or piston rod tube, the spindle being allocated to a unit that halts the rotational displacement. The spindle or a rotational sleeve that is placed over the spindle has a radial pressure chamber, in which a locking bolt engages, said bolt being introduced radially.

The invention relates to a lockable working cylinder having a housing and having a piston which is moveable therein in a main pressure space, from which piston a piston rod tube leads out of the main pressure space, with a spindle rotating in the piston or in the piston rod tube, which spindle is assigned a device for stopping the rotational movement.

### PRIOR ART

Working cylinders of said type are known and commercially available in a wide variety of forms and embodiments. For example, DE 41 41 460 C2 presents a pressure-medium-operated working cylinder in which a rotatable spindle engages into a piston rod tube. If the corresponding piston which is assigned to the piston rod tube is subjected to pressure, then the spindle also rotates, such that the piston rod tube can move axially.

In all of said working cylinders, there is the problem that, if the pressure in the actual main pressure space in which the piston is acted on with pressure collapses, for example as a result of failure of the sealing collar, the piston is automatically set in motion under the pressure of the load or else under tension, wherein the spindle, with its outer thread, runs down the inner thread of the piston rod tube.

In order to prevent said automatic movement of the piston rod, corresponding braking or locking units are provided. For example, DE 297 20 838 U1 proposes a braking face which presses against a brake cone such that the spindle rotation is braked in this way. A brake device of said type is not suitable for braking relatively high loads which act on the working cylinder. In addition, the spindle rotation cannot be abruptly ended in this way.

Also known, from DE 202 16 197, is a locking unit which forms a functionally reliable, finely stepped and reliably lockable component arrangement. Here, a locking unit which brakes the rotational movement of the threaded spindle by means of an axially moveable connecting element and a rotationally fixed mating element is provided, with it being possible for the connecting element, which is held in a connecting position by means of a pressure spring, to be unlocked by means of a sliding body which can be displaced counter to the spring action. The connecting element is embodied as a latching piston which is axially moveable with the pressure spring on a load-bearing shoulder part of the threaded spindle, on that end side of which latching piston which points toward the end-side end of the cylinder base is provided a toothing profile which runs in a circular ring shape and can latch into a base-side mating toothing. The latching piston which is moveable on the load-bearing shoulder part is aligned rotatably on the sliding body coaxially with respect to said toothing profile by means of a central thrust bearing. Said locking is problematic, since on the one hand, an end-side locking arrangement can be worn down over the course of time. On the other hand, the cohesion of the end-side toothing is dependent on the pressure medium loading which can fail slightly for example if leakages occur.

### Object

It is an object of the present invention to create a working cylinder of the type specified above in which very rapid and secure locking of the piston or of the piston rod tube or of the spindle takes place when the pressure in the main pressure space is removed.

### Achievement of the Object

The object is achieved in that the spindle or a rotary sleeve which is placed on said spindle has a radially arranged pressure space into which engages a radially guidable blocking bolt.

Said radially guidable blocking bolt serves to ensure that, if it is inserted into the pressure space, secure locking of the spindle takes place. The piston and also the piston rod tube are also fixed in this way. A further rotational movement is possible only once the blocking bolt is removed from its latching position.

Where reference is made below merely to a spindle, then said spindle also comprises a rotary sleeve which is placed onto the spindle, which rotary sleeve serves for better assembly and bearing of the spindle.

For the movement of the blocking bolt into and out of the latching position, various possibilities are conceivable. In one exemplary embodiment, the pressure space is under the pressure of a pressure medium which presses the blocking bolt out of the pressure space. In this way, the spindle is freed and can rotate.

At the other side from the pressure space, the blocking bolt could be assigned a force store such as for example a coil spring. If, in this case, the pressure in the pressure space is removed, the blocking bolt can move into said pressure space under the pressure of the pressure spring, and lock the spindle.

It is also conceivable, together with a coil spring or even without the coil spring, for the blocking bolt to be placed under the pressure of a hydraulic or pneumatic medium at the other side from the pressure space, such that, in a manner controlled by a corresponding electronic controller, pressure is built up and the blocking bolt can be moved in the pressure space. Here, many possibilities are conceivable and are to be encompassed by the invention.

It is however preferable overall for a pot-shaped locking pressure space to be set up around the spindle end, from which locking pressure space the pressure space, which holds the blocking bolt, then branches off. From said pot-shaped locking pressure space, a pressure medium passes into the pressure space, since the blocking bolt is guided there with play. If the base of the space is of funnel-shaped design, then the pressure medium can pass in front of the blocking bolt and push the latter out of the pressure space. The funnel-shaped design is however not imperative.

The latter arrangement is primarily desirable if a plurality of pressure spaces are distributed radially around the spindle or the spindle end. Said radial distribution has the effect that the blocking bolt has a plurality of desired possibilities for moving into the next pressure space. In this way, the undesired rotation of the spindle, which for example follows a leakage in the system, is reduced to a minimum.

It is better still if more than one blocking bolt is provided, since then the fixing of the spindle is stabilized. It is also possible to design the spacing between two blocking bolts to be not equal to the spacing between two pressure spaces, such that the pitch for the locking action is further reduced. This means that the rotation of the spindle is reduced to a minimum.

An annular collar should preferably be provided on the spindle or on the above-mentioned rotary sleeve, which annular collar is supported against at least one needle bearing. Said needle bearing absorbs the axially-acting forces, with a spindle end face preferably still maintaining a slight spacing from a blind hole base of a blind hole which surrounds it.

In one preferred exemplary embodiment, the entire pressure medium system is coupled to one another. This means primarily that the pressure medium supply for moving the actual piston is coupled to the pressure medium supply to the above-mentioned locking pressure space for the blocking bolt. However, the pressure medium supply to the locking pressure space and the main pressure space takes place in a controlled manner. Here, it is significant that the locking pressure space is separated from the main pressure space by a corresponding seal. The pressure medium supply to the main pressure space is designed such that the pressure medium supply to the locking pressure space first reaches a predetermined value, for example of from 15 to 25 bar, which is sufficient to press the blocking bolt out of the pressure space, before the piston in the main pressure space is acted on with pressure. That is to say, the spindle is first unlocked before it is moved axially in the working cylinder. The blocking bolt therefore assumes a second, mechanical securing action, while the first securing action is provided hydraulically by means of at least one load-holding valve. Said load-holding valve is arranged in the pressure medium system in such a way that it can hold a force which acts on the piston rod or on the piston once the pressure medium supply, for example the hydraulic unit, is deactivated. Only once said first securing action no longer functions, for example in the case of a faulty load-holding valve or in the event of a leakage in the system, does the second, mechanical securing action come into force, since in this case the spindle rotates, and the blocking bolt moves, under the pressure of the coil spring which supports it, into the pressure space.

The present working cylinder is intended primarily for large loads. The field of application is extremely varied. Said field of application runs from for example double-level car transporters, in which the individual levels are supported against one another, to hydraulic presses or else devices for placing shells in the building industry. These are only a small number of application examples, and the invention is of course not restricted to these.

### DESCRIPTION OF THE FIGURES

Further advantages, features and details of the invention can be gathered from the following description of a preferred exemplary embodiment and on the basis of the drawing, in which:

FIG. 1 shows a plan view of a working cylinder according to the invention;

FIG. 2 shows a front view of the working cylinder as per FIG. 1;

FIG. 3 shows a cross section through the working cylinder as per the line III-III in FIG. 2.

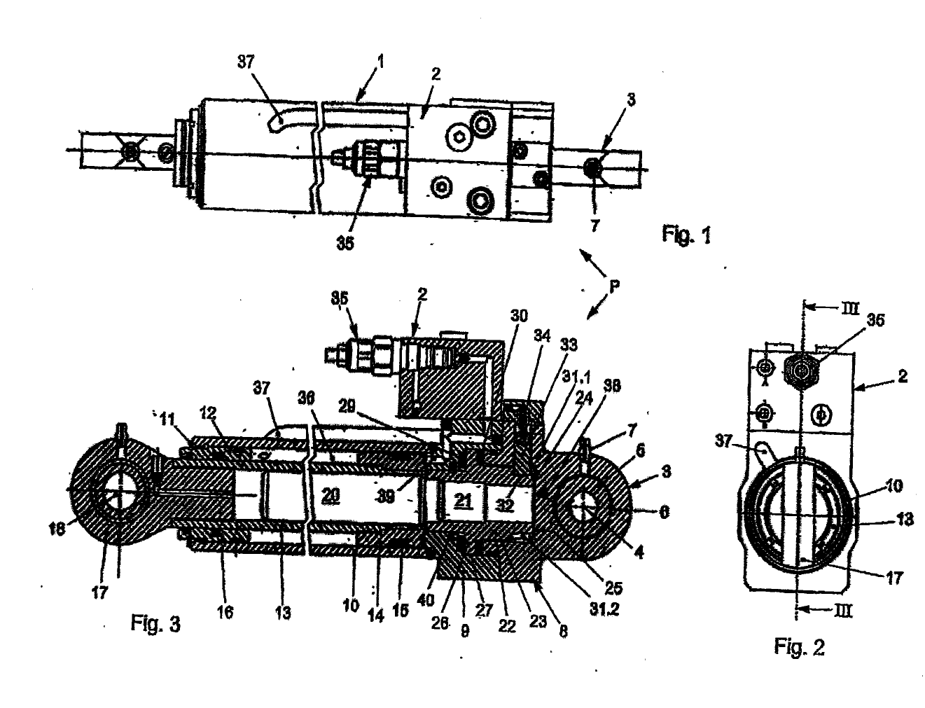

A working cylinder P according to the invention has, as per FIG. 1, a housing 1 on which is placed a distributor block 2 for pressure media. At the right-hand side, the housing 1 has integrally formed on it a lug 3 with an eye 4 for being hooked onto a hook or the like (not shown in any more detail). The eye 4 is seated in a rotary ring 5, with the latter forming an annular space 6 in the direction of the lug 3, which annular space 6 can be filled with a lubricant via a lubricating means 7.

The lug 3 is adjoined by a lower housing part 8 onto which is pushed a housing central part 9. The latter merges in turn into a cylindrical tube 10, into the opening 11 of which is inserted a guide sleeve 12. The guide sleeve 12 surrounds a piston rod tube 13 which is screwed into a piston 14. The piston 14 is guided in the interior of the cylindrical tube 10 and is supported against said cylindrical tube 10 via a sealing ring 15.

A threaded piece 16 is screwed into an open end of the piston rod tube 13, which threaded piece 16 merges in one piece into a further lug 17 having a connecting eye 18 for example for a load or snap hook.

The piston rod tube 13 is provided at least largely with an internal thread (not illustrated in any more detail) in which a spindle 20 having a corresponding external thread rotates. Said spindle 20 also extends through the piston 14 and is seated with a spindle foot 21 in a rotary sleeve 22 which is held by the housing central part 9 and the lower housing part 8. For this purpose, the lower housing part 8 forms a blind hole 23 in which the rotary sleeve 22 is held with a spacing. Here, the rotary sleeve 22, with an end face 24, maintains a slight spacing from a blind hole base 25.

In addition, the rotary sleeve 22 engages, with an annular collar 26, into an annular space 27 which is formed between the housing central part 9 and the lower housing part 8. In said annular space 27, the annular collar 26 is supported at both sides, in each case via a needle bearing 29 and 30, against corresponding shoulder or end faces which are formed by the housing parts.

Close to the end face 24, at least two pressure spaces 31.1 and 31.2 are formed into the rotary sleeve 22, which pressure spaces 31.1 and 31.2 are in each case provided with a funnel-shaped base 32. Seated in the pressure space 31.1 is a blocking bolt 33 which is acted on at the other side by a coil spring 34.

Since the rotary sleeve 22 maintains a slight spacing to the blind hole 23 and, likewise, the end face 24 maintains a slight spacing to the blind hole base 25, said spaces together form a pot-shaped locking pressure space 38. Said locking pressure space 38 is separated from the main pressure space 36 by an annular seal 40 which is arranged behind the needle bearing 29 between the rotary sleeve 22 and housing central part 9.

The mode of operation of the working cylinder according to the invention is as follows:

Pressure medium is supplied, by means of a pressure line (not shown in any more detail), through the distributor block 2 to the locking pressure space 38. Since the blocking bolt 33 is guided in the pressure space 31.1 with play, said pressure medium passes in front of the blocking bolt 33 into the funnel base 23, and presses the blocking bolt 33, counter to the force of the coil spring 34, out of the pressure space 31.1. As a result, the rotary sleeve 22 can rotate freely in the blind hole 23, with the rotation being assisted by the needle bearings 29 and 30.

Once the pressure in the locking space 38 has reached a certain value, for example 20 bar, at which it is ensured that the blocking bolt 33 is pressed out of the pressure space 31.1, pressure medium also passes behind the piston 14. The latter is moved to the left, such that a pressure space 36 in front of the piston 14 is reduced in size. The volume of pressure medium from said pressure space 36 passes through a return line 37 back to for example a pressure medium accumulator.

A pitch of the internal thread (not shown) in the piston rod tube 13 and of the external thread (not shown) on the spindle 20 is selected such that, in the event of the movement of the piston rod tube 13 under the pressure of the piston 14 to the left, the spindle 20 is set into a rotary motion.

During the supply of pressure medium behind the piston 14, the hydraulic system is controlled such that, in the locking pressure space 38, there is always a prevailing pressure of 15 to 25 bar higher than in the main pressure space 36. This ensures that the blocking bolt 33 remains in its pushed-back position.

If the piston rod tube 13 has now reached its desired end position, the hydraulic unit does not feed any more pressure medium either to the main pressure space 36 or to the locking pressure space 38. This means that both pressure spaces are unpressurized. However, it is also not possible for any pressure medium to flow back out of the pressure space behind the piston 14, since this is prevented by a load-holding valve 35. Said load-holding valve provides the first securing action of the lockable working cylinder according to the invention. The second securing action is assumed by the blocking bolt 33. The latter bears against the periphery of the rotary sleeve 22 since the locking pressure space 38 is unpressurized.

If, for any reason, a rotation of the spindle 20 takes place, for example as a result of leakage of the main pressure space 36 or a malfunction of the load-holding valve 35, the blocking bolt 33, which is pressed radially against the rotary sleeve 22 under the pressure of the coil spring 34, is pressed into a corresponding pressure space 31.1 or 31.2 once the rotation of the rotary sleeve 22 rotates said pressure space 31.1 into the region of the blocking bolt 33. In this way, a further rotation of the spindle 20 is prevented, so that the piston rod tube 13 must also pause in its position. A release of said locking can take place again only once pressure medium flows into the locking pressure space 38, and the blocking bolt 33 is pushed out of its latching position in the pressure space 31.1.

### LIST OF REFERENCE SYMBOLS

1 Housing
2 Distributor block
3 Lug
4 Eye
5 Rotary ring
6 Annular space
7 Lubricating means
8 Lower housing part
9 Housing central part
10 Cylindrical tube
11 opening
12 Guide sleeve
13 Piston rod tube
14 Piston
15 Seal
16 Threaded piece
17 Lug
18 Eye
19
20 Spindle
21 Spindle foot
22 Rotary sleeve P Working cylinder
23 Blind hole
24 End face
25 Blind hole base
26 Annular collar
27 Annular space
28
29 Needle bearing
30 Needle bearing
31 Pressure space
32 Funnel base
33 Blocking bolt
34 Coil spring
35 Load-holding valve
36 Pressure space
37 Return line
38 Locking pressure space
39 Pressure medium feed line
40 Annular seal

1-17. (canceled)

18. A lockable working cylinder comprising a housing and a piston which is moveable therein in a main pressure space, a piston rod tube extends from the piston and leads out of the main pressure space, with a spindle rotatably mounted in one of the piston and the piston rod tube, a device for stopping the rotational movement of the spindle, wherein the spindle or a rotary sleeve which is placed on said spindle has a radially arranged pressure space into which engages a radially guidable blocking bolt.

19. The working cylinder as claimed in claim 18, wherein the blocking bolt is acted on with pressure by a force stored at the other side from the pressure space.

20. The working cylinder as claimed in claim 19, wherein the force stored is a coil spring.

21. The working cylinder as claimed in claim 19, wherein the force stored is a hydraulic or pneumatic pressure source which opens out into a pressure space behind the blocking bolt.

22. The working cylinder as claimed in claim 18, wherein the blocking bolt is guided in the pressure space with play.

23. The working cylinder as claimed in claim 18, wherein the radially arranged pressure space has a funnel base.

24. The working cylinder as claimed in claim 18, wherein a plurality of pressure spaces are distributed radially around the spindle or around the rotary sleeve and are connected to a port on a pressure source.

25. The working cylinder as claimed in claim 24, wherein more than one blocking bolt is provided in a radially guidable fashion.

26. The working cylinder as claimed in claim 25, wherein a spacing between two blocking bolts is not equal to the spacing between two pressure spaces.

27. The working cylinder as claimed in claim 25, wherein the spindle or the rotary sleeve forms an annular collar which is supported at least remote from the piston against a bearing.

28. The working cylinder as claimed in claim 18, wherein the spindle or the rotary sleeve rotates in a blind hole in the housing and maintains a spacing from a blind hole base.

29. The working cylinder as claimed in claim 28, wherein, in the blind hole, a locking pressure space is formed toward the spindle or the rotary sleeve.

30. The working cylinder as claimed in claim 21, wherein the pressure space in front of the blocking bolts and the main pressure space in front of the piston, are connected to a same pressure source.

31. The working cylinder as claimed in claim 30, wherein the pressure space is separated from the main pressure space in front of the piston by a seal.

32. The working cylinder as claimed in claim 18, wherein the main pressure space is protected in front of and/or behind the piston by means of a load-holding valve.

33. The working cylinder as claimed in claim 30, wherein the pressure space is pressurized with a higher pressure than the main pressure space.

34. The working cylinder as claimed in claim 33, wherein the main pressure space is pressurized only once the pressure in the pressure space has reached a predetermined value.

35. A lockable working cylinder comprising housing means, a piston fixedly mounted on a hollow piston rod, said piston and hollow piston rod being movable within said housing means, said hollow piston rod defines with said housing means a main pressure space on one side of said piston, a spindle threaded into said hollow piston rod for rotatable movement therein, said spindle extends through said piston and is seated in a rotary sleeve, said rotary sleeve is mounted in said housing means and space therefrom so as to form at least two pressure spaces, a blocking bolt mounted in said housing means, said blocking bolt having a first side acted on by biasing means for pressing a second side of said blocking bolt against the rotary sleeve for blocking rotatable movement of same, wherein said second side is exposed to at least one of the at least two pressure spaces, and means for feeding a pressure medium to said second side of said blocking bolt and to an other side of the piston to bias said blocking bolt against said biasing means so as to allow said rotary sleeve to rotate and said piston and hollow piston rod to move in said main pressure space.
